(19) United States
(12) Patent Application Publication
(10) Pub. No.: US 2022/0415532 A1
(43) Pub. Date: Dec. 29, 2022

(54) MOBILE COMPRESSION AND MELTING COMPOSITE VOLUME REDUCTION SYSTEM AND METHOD FOR TREATING NON-COMBUSTIBLE WASTE OF DISMANTLED NUCLEAR POWER PLANT

(71) Applicants: ORION ENC CO., LTD., Seoul (KR); SEOUL MACHINERY CO., LTD., Siheung-si, Gyeonggi-do (KR)

(72) Inventor: Un Jang LEE, Seoul (KR)

(73) Assignees: ORION ENC CO., LTD., Seoul (KR); SEOUL MACHINERY CO., LTD., Siheung-si, Gyeonggi-do (KR)

(21) Appl. No.: 17/775,792

(22) PCT Filed: Feb. 27, 2020
(86) PCT No.: PCT/KR2020/002815

§ 371 Date: May 10, 2022

(30) Foreign Application Priority Data
Feb. 26, 2020 (KR) 10-2020-0023808

(51) Int. Cl. G21F 9/30

(52) U.S. Cl. CPC G21F 9/30

(57) ABSTRACT

The present invention relates to a mobile compacting and melting complex volume reduction system (1) of radioactive waste. The complex volume reduction system (1) includes a mobile vehicle (3); a volume reducing part (7) that is disposed at one side of the inside of a container (5) mounted on the vehicle (3), and that presses and compacts dry active waste; a melting part (9) that is disposed at one side of the inside of the container (5) to melt the dry active waste by heat of a high temperature; and an exhaust gas processing part (11) that is connected to the melting part (9) to exhaust discharged gas to the outside.

### CROSS-REFERENCE TO RELATED APPLICATION(S)

This application is a national entry of International Application No. PCT/KR2020/002815, filed on Feb. 27, 2020, which claims under 35 U.S.C. § 119(a) and 365(b) priority to and benefits of Korean Patent Application No. 10-2020-0023808, filed on Feb. 26, 2020 in the Korean Intellectual Property Office, the entire contents of which are incorporated herein by reference.

### TECHNICAL FIELD

The present invention relates to a mobile compacting and melting complex volume reduction system and method of nuclear power plant waste, and more particularly, to a technology that, by installing a system capable of compacting and melting dry active waste of nuclear power plant waste in a vehicle and movably configuring it, may access a processing place without restrictions and that may selectively perform compacting or melting according to types of radioactive waste.

### BACKGROUND ART

Generally, dry active waste of low- and intermediate-level radioactive wastes generated from nuclear power plants is volume-reduced and stored by using a compactor and the like, and currently, it is compacted at a pressure of about 10 tons by using a compactor with a capacity of 30 tons.

An example of an apparatus for volume-reducing such dry active waste material is disclosed in Patent Registration No. 10-1561522, which was previously applied and registered by the present applicant.

The present embodiment relates to an apparatus for compacting and storing dry active waste of radioactive waste, and it is configured of a vibrating part capable of vibrating in a multi-axis direction by placing a drum, a compactor that is disposed on an upper portion of the drum to increase a filling rate by compacting dry active waste inside the drum by up-and-down reciprocating motion, and a height sensing part that may sense a degree of filling by measuring a height of the dry active waste.

However, the above-described conventional dry active waste compacting apparatus has the following problems.

First, since a plasma volume reduction facility for melting and incineration of radioactive waste is of a fixed type, when it is necessary to treat radioactive waste, the waste must be transported directly to a place where the volume reduction facility is installed and processed, so that there are problems in that it is cumbersome and it may not efficiently respond when urgent processing is required.

Second, there is a problem that the radioactive waste volume reduction compactor has low compacting force, so spring-back occurs and metal waste may not be volume-reduced.

Third, since an apparatus for melting radioactive waste is separately provided, it is difficult to perform a volume reduction process and a melting process together, and after performing a compacting process at a volume reduction facility, it takes a long time to process because the melting process must be performed by moving to a melting furnace.

Fourth, a conventional melting process has a problem in that secondary waste occurs due to processing of exhaust gas occurring in the melting process, characteristics of a glass solidified body are not good, and volatile radioactive cesium is introduced into a large amount of exhaust gas processing process.

### DISCLOSURE

### Technical Problem

Therefore, the present invention is proposed to solve the above problems, and an objective of the present invention is to provide a technology that, by installing a system capable of compacting and melting dry active waste of nuclear power plant waste in a vehicle and movably configuring it, may access a processing place without restrictions and that may selectively perform compacting or melting according to types of radioactive waste.

Another objective of the present invention is to provide a technology capable of simultaneously performing volume reduction and melting of radioactive waste by disposing both a radioactive waste melting furnace and a volume reducing part in a vehicle.

Another objective of the present invention is to provide a technology that may prevent damage to a drum by putting dry active waste in a compacting mold and storing it in a storage drum by using a compactor and also adding a filling material to an empty space together and that may improve stability by preventing an empty space from being formed in the drum.

Another objective of the present invention is to provide a technology in which it is possible to effectively treat exhaust gas generated from an apparatus when radioactive waste is treated in a melting furnace, characteristics of a glass solidified body are good, and it is possible to reduce a generation amount of volatile radioactive cesium.

### Technical Solution

In order to realize the above objective, an embodiment of the present invention provides a mobile compacting and melting complex volume reduction system (1), including:

a volume reducing part (7) that is disposed at one side of the inside of a container (5) mounted on the vehicle (3), and that presses and compacts dry active waste;

a melting part (9) that is disposed at one side of the inside of the container (5) to melt the dry active waste by heat of a high temperature; and

an exhaust gas processing part (11) that is connected to the melting part (9) to exhaust discharged gas to the outside.

In addition, the volume reducing part (7) includes an upper frame (10); first to third hydraulic cylinders (12, 13, 14) that are disposed at the upper frame (10) side to ascend or descend; a pressure press (37) that compacts the dry active waste by being connected to a lower portion of the first hydraulic cylinder (12) to ascend or descend; an inner mold (51) that is disposed under the pressure press (37) and in which the dry active waste is stored therein as a cylindrical shape to be pressed by the pressure press (37); an outer mold (53) that is disposed to surround the outside of the inner mold (51) and has a cylindrical shape; a connecting member (38) that lifts and lowers the outer mold (53) by connecting the second hydraulic cylinder (13) and the outer mold (53); a mold tray (55) that is detachably mounted on lower portions of the inner and outer molds (51, 53) to seal a lower portion thereof; a lower support part (43) that is connected to a lower portion of the third hydraulic cylinder (14) to ascend or descend and in which the mold tray (55) is mounted on at upper side thereof; a rail (50) that is disposed in a rail groove (56) formed in the lower support part (43), and supports a lower portion of the mold tray (55) by ascending or descending to move up or down and forward and backward it; and entrance and exit conveyors (31, 33) that are respectively disposed at entrance and exit sides of the lower support (43) to move the mold tray (55) to take out the inner mold (51) to the outside or move it to an inner pressing position.

The mold tray (55) has a plate shape, and the inner and outer molds (51, 53) are mounted on an upper portion thereof, a pair of coupling grooves (h) are formed in a lower portion thereof, and a pair of rails (50) are respectively coupled to the coupling groove (h).

The inner mold (51) and the outer mold (53) are integrally coupled or separated by a handle (39).

The melting part (9) includes a plasma melting furnace (17) in which the dry active waste is stored; a plasma torch (19) that is disposed in the plasma melting furnace (17) and generates ultra-high heat by electric arc to generate gaseous plasma to melt the dry active waste; and a manipulator (15) that controls a direction of the plasma torch (19).

Another embodiment of the present invention provides a mobile compacting and melting complex volume reduction method, including:

a first step (S10) in which contamination measurement and classification of radioactive waste is performed;

a second step (S15) of cutting and decommissioning the radioactive waste when it is determined to be contaminated;

a third step (S20) of desalinizing the radioactive waste;

a fourth step (S25) of measuring radiation thereof;

a fifth step (S30) of performing again the first step (S10) when the measurement result is greater than or equal to an intermediate level and of storing the radioactive waste in the inner mold (51) is performed when the measurement result is smaller than or equal to a low level;

a sixth step (S35) of classifying the inner mold (51) in which the radioactive waste is stored into compressible, incompressible, combustible, and non-combustible ones, and classifying it into an object to be processed by conveying it to the volume reducing part (7) and an object to be processed by conveying it to the melting part (9);

a seventh step (S40), after being classified in the sixth step (S35), of conveying the inner mold (51) to the volume reducing part (7) to compact it; and

an eighth step (S45), after being classified in the sixth step (S35), of conveying the inner mold (51) to the molten part (9) and melting it.

### Advantageous Effects

The compacting and volume reducing system and method of the dry active waste of the radioactive waste according to the embodiment of the present invention described above have the following merits.

First, a system that may compact and melt dry active waste of nuclear power plant waste is mounted on a vehicle to be configured to be portable, so that the dry active waste may be processed by accessing a treatment site without restrictions.

Second, it is possible to prevent damage to a drum by putting dry active waste in a compacting mold and storing it in a storage drum by using a compactor and also adding a filling material to an empty space together, and it is possible to improve stability by preventing an empty space from being formed in the drum.

Third, by improving a structure of a volume reducing part, a process of inserting, compacting, and discharging an inner mold in which dry active waste is stored inside the volume reducing part is automated, so that a volume reducing process may be easily performed.

Fourth, when radioactive waste is treated in a melting furnace, exhaust gas generated from an apparatus may be effectively treated, characteristics of a glass solidified body is good, and an generated amount of volatile radioactive cesium may be reduced.

Fifth, compacting or melting may be selectively performed depending on a type of radioactive waste by disposing a radioactive waste melting furnace and a volume reducing part in a vehicle together.

### DESCRIPTION OF THE DRAWINGS

FIG. 1 illustrates a structure of a mobile dry active waste melting and compacting volume reduction system of radioactive waste according to an embodiment of the present invention.

FIG. 2 illustrates a perspective view of an appearance of a compacting volume reducing part shown in FIG. 1.

FIG. 3 illustrates a front view of FIG. 2.

FIG. 4 illustrates a top plan view of FIG. 2.

FIG. 5 illustrates a perspective view of an internal structure of the compacting volume reducing part shown in FIG. 2.

FIG. 6 illustrates a front view of the internal structure of the compacting volume reducing part shown in FIG. 2.

FIG. 7 illustrates an exploded perspective view of the structure of the compacting volume reducing part shown in FIG. 2.

FIG. 8 illustrates a perspective view of coupling relationship between a mold plate and a rail and a lower support shown in FIG. 7.

FIG. 9 illustrates a flowchart of a process of selectively processing radioactive waste by the mobile dry active waste melting and compacting volume reduction system shown in FIG. 1.

### MODE FOR INVENTION

Hereinafter, a mobile compacting and melting complex volume reduction system according to an embodiment of the present invention will be described in detail with reference to the accompanying drawings.

The present complex volume reduction system (1) is a system that volume-reduces waste generated during decommissioning of a nuclear power plant on site, and is a moving method that combines compacting and melting.

This system (1) has a structure that may be performed in connection with compacting and melting processes by classifying various types of decommissioning wastes generated during decommissioning of a nuclear power plant according to volume reduction characteristics and may be easily moved to a decommissioning site. In this case, the decommissioning waste may be variously classified, for example, it may be classified into compact and non-compact waste, or it may be classified into combustible and non-combustible waste.

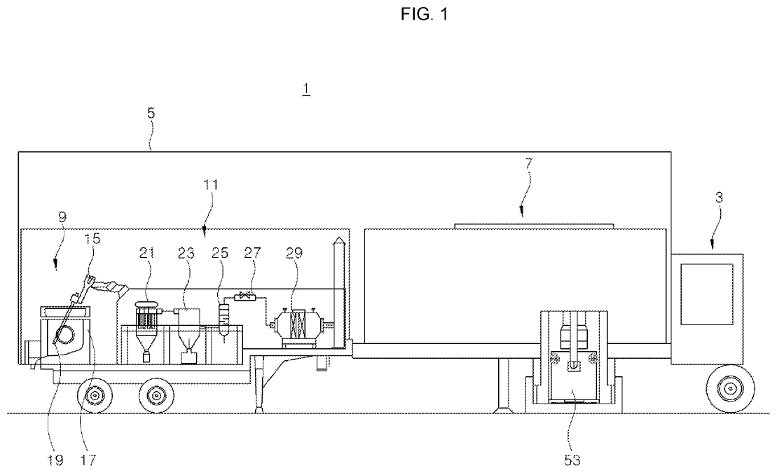

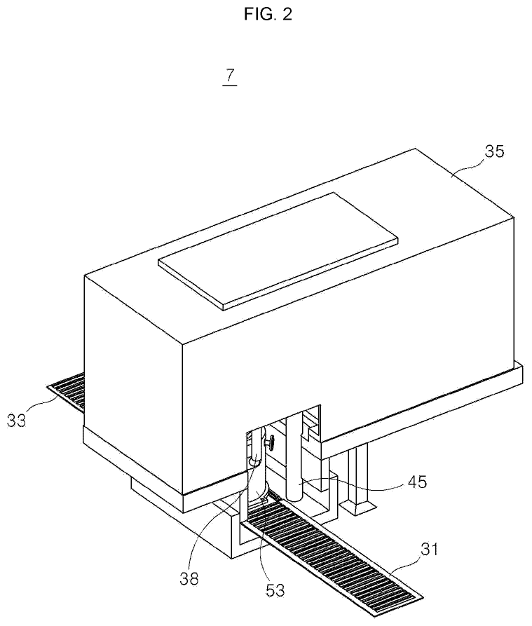

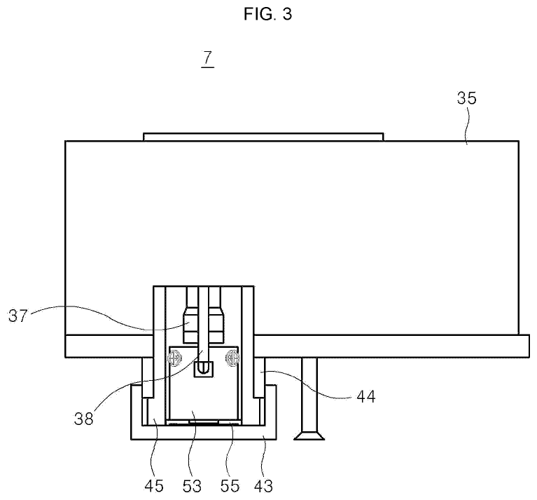

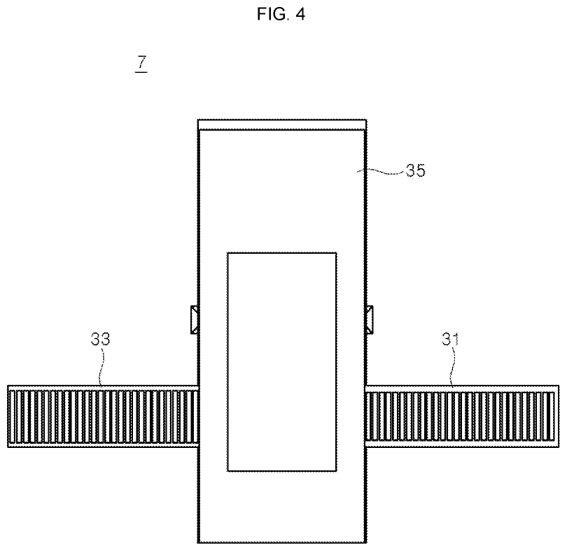

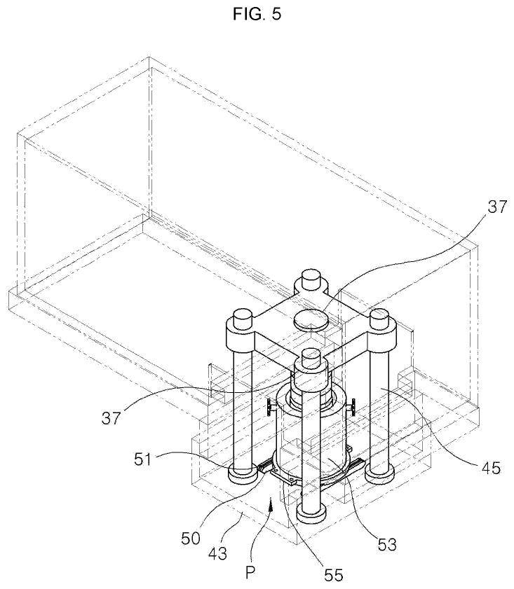

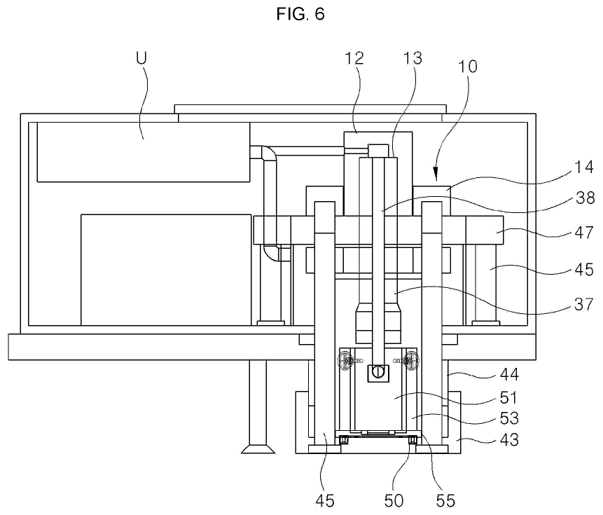

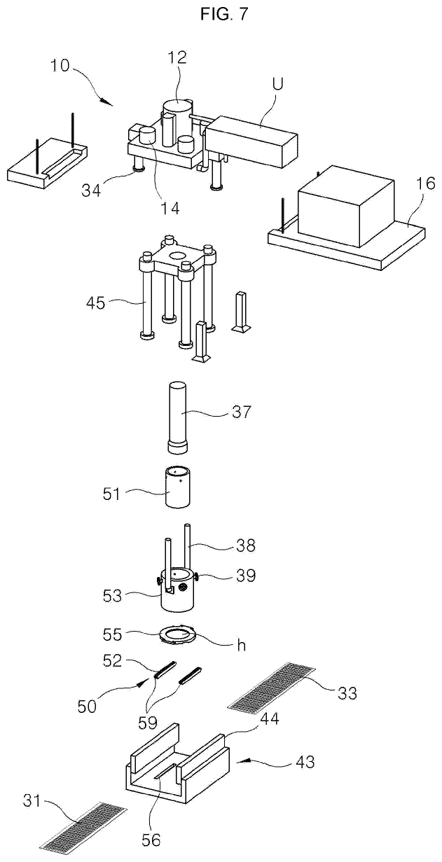

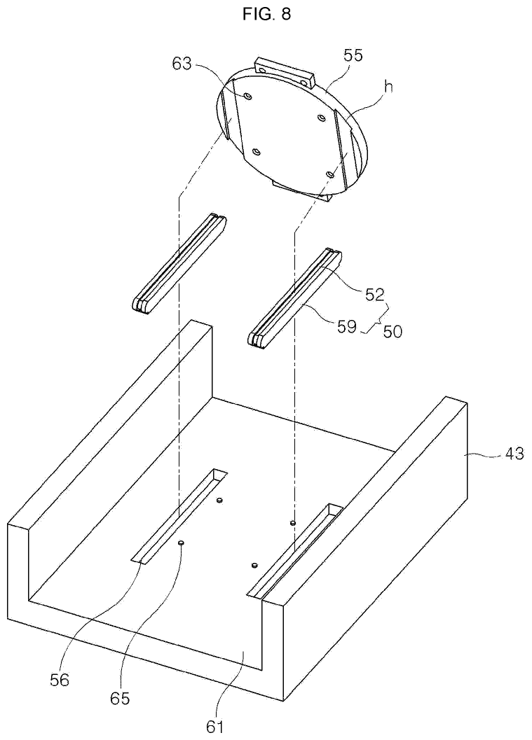

As shown in FIG. 1 to FIG. 9, the complex volume reduction system (1) proposed by the present invention includes a movable vehicle (3); a volume reducing part (7) that is disposed at one side of an inner portion of a container (5) mounted on the vehicle (3) to compact dry active waste; a melting part (9) that is disposed at one side of the inner portion of the container (5) to melt the dry active waste; and an exhaust gas processing part (11) that is connected to the melting part (9) to exhaust discharged gas to the outside.

In the complex volume reduction system (1) having the above-described structure,

the volume reducing part (7) is disposed inside a case (35) provided inside the container (5), so that it compacts dry active waste, which is radioactive waste stored in an inner drum.

In more detail,

the volume reducing part (7) includes an upper frame (10) disposed at the inside of the case (35); first to third hydraulic cylinders (12, 13, 14) that are disposed at the upper frame (10) side to ascend or descend; a pressure press (37) that compacts the dry active waste by being connected to a lower portion of the first hydraulic cylinder (12) to ascend or descend; an inner mold (51) that is disposed under the pressure press (37) and in which the dry active waste is stored therein as a cylindrical shape to be pressed by the pressure press (37); an outer mold (53) that is disposed to surround the outside of the inner mold (51) and has a cylindrical shape; a connecting member (38) that lifts and lowers the outer mold (53) by connecting the second hydraulic cylinder (13) and the outer mold (53); a mold tray (55) that is detachably mounted on lower portions of the inner and outer molds (51, 53) to seal a lower portion thereof; a lower support part (43) that is connected to a lower portion of the third hydraulic cylinder (14) to ascend or descend and in which the mold tray (55) is mounted on at upper side thereof; a rail (50) that is disposed in a fixing groove formed in the lower support part (43), and supports a lower portion of the mold tray (55) by ascending or descending to move up or down and forward and backward it; and entrance and exit conveyors (31, 33) that are respectively disposed at entrance and exit sides of the lower support (43) to move the mold tray (55) to take out the inner mold (51) to the outside or move it to an inner pressing position.

In more detail, in the volume reducing part (7),

a plurality of legs (34) protrude from the lower portion of the upper frame (10), and the plurality of legs (34) are disposed on an upper portion of a base (16) disposed inside the case (35). In addition, the first to third hydraulic cylinders (12, 13, 14) are disposed in the upper frame (10), and each hydraulic cylinder is connected to a hydraulic supply part (U) disposed at one side thereof.

The pressure press (37) is connected to the lower portion of the first hydraulic cylinder (12) to ascend or descend. The pressure press (37) is disposed on the same vertical line as the inner mold (51), so that when the inner mold (51) reaches the compacting position (P), it descends to press the dry active waste stored in the inner mold (51). In this case, the inner mold (51) is integrally coupled to the outer mold (53).

In addition, after pressurization, as will be described later, the pressure press (37) is lifted by driving of the first hydraulic cylinder (12), and in this case, the connecting member (38) is also lifted by driving of the second hydraulic cylinder (13), so that the outer mold (53) is also lifted, and since the inner mold (51) is integrally coupled thereto, the inner mold (51) is also lifted.

As a result, only the dry active waste compacted inside the inner mold (51) is left at an upper side of the mold tray (55).

The inner mold (51) has a container shape, for example, a cylindrical shape, and the dry active waste may be stored therein to be pressed by pressure press (37).

The inner mold (51) may be inserted into the inner side of the outer mold (53) to be integrally coupled thereto or separated therefrom.

That is, when the inner mold (51) is coupled to the outer mold (53), a handle (39) may be rotated to be integrally coupled thereto, and when the inner mold (51) is separated therefrom, the handle (39) may be rotated in an opposite direction to release a coupling state, thereby being separated therefrom.

In a state in which the inner mold (51) is seated on the upper side of the mold tray (55) at the compacting position (P), when a belt (52) of the rail (50) is rotated by a driving source such as a motor (not shown), the rail (50) may be moved in the direction of the entrance conveyor (31), and the mold tray (55) may be moved to the entrance while the mold tray (55) is placed on the entrance conveyor (31).

In addition, when the dry active waste is supplied to the inner mold (51) at the entrance side, it is returned to an original position, which is the compacting position (P), by the entrance conveyor (31) again.

The outer mold (53) is disposed in a structure surrounding the outer side of the inner mold (51) as described above, and is connected to the second hydraulic cylinder (13) by the connecting member (38).

Accordingly, when the second hydraulic cylinder (13) is driven, the connecting member (38) is lifted and lowered, and the outer mold (53) is also lifted and lowered. In this case, when the inner mold (51) is integrally coupled thereto, the inner mold (51) is also lifted and lowered.

The mold tray (55) has a plate shape, for example, a disc shape. The inner and outer molds (51, 53) are placed on the upper portion of the mold tray (55), and the lower portion thereof is seated on the rail (50).

In this case, a pair of coupling grooves (h) are formed on a bottom surface of the mold tray (55), and a pair of rails (50) may be coupled to the coupling grooves (h), respectively. In addition, a plurality of fixing grooves (63) are formed on the bottom surface of the mold tray (55), and the fixing grooves (63) are coupled to a plurality of fixing protrusions (65) protruding upward from a support plate (61) of the lower support part (43).

Accordingly, the mold tray (55) may be seated at an accurate position of the lower support part (43).

In addition, each of the pair of rails (50) includes a body 59; a belt (52) disposed on the body 59 in a longitudinal direction to be rotatable together with a conveyor in a front-rear direction; and a motor (not shown) for rotating the belt (52).

Accordingly, in a state in which the mold tray (55) is placed on the upper portion of the pair of rails (50), when the motor is driven, the belt (52) may frictionally contact the bottom surface of the mold tray (55) to move the mold tray (55) to the entrance direction or the exit direction.

Of course, the present invention is not limited thereto, and in order to draw out the mold tray (55) to the outside, it is possible to pull the mold tray (55) by mounting a winch on the outside of the volume reducing part.

In addition, the pair of rails (50) are mounted in the rail groove (56) formed in the lower support part (43), respectively.

In addition, the lower support part (43) is connected to the lower portion of the third hydraulic cylinder (14) to be lifted or lowered if necessary. The lower support part (43) is lifted and lowered in a state guided by a pair of guides disposed at an upper adjacent position thereof.

Accordingly, since the lower support part (43) may be lifted or lowered along an accurate path, when a vehicle stops and a volume reduction operation is performed, the lower support part (43) is lowered to the ground, and when moving after the operation is completed, the lower support part (43) is lifted to the inside of the container.

The entrance and exit conveyors (31, 33) are respectively disposed to the entrance and exit sides of the volume reducing part (7) to move the mold tray (55) and the inner mold (51). The entrance and exit conveyors (31, 33) refer to conveyors having a conventional structure, and since a direction of each roller may be changed in forward and reverse directions, the mold tray (55) and the inner mold (51) may be moved to an outer or inner direction of the volume reducing part (7) as necessary.

Meanwhile, an operation process of the volume reducing part (7) having the structure described above will be sequentially described as follows.

As shown in FIG. 1 to FIG. 8, initially, the lower support part (43) is lowered to the compacting position (P) by the driving of the third hydraulic cylinder (14). In this case, the rail (50) is mounted in the rail groove (56) of the lower support part (43), and the mold tray (55) and the inner mold (51) are seated on the upper side thereof. In addition, the pressure press (37) is positioned at the upper side.

In this state, as the second hydraulic cylinder (13) is driven, the connecting member (38) is lifted, and the outer mold (53) is lifted.

When the outer mold (53) is lifted to reach a predetermined height, the rail (50) of the lower support part (43) is lifted to a predetermined height.

After the rail (50) is lifted, the belt (52) is rotated in the front-rear direction, so that the mold tray (55), and the inner mold (51) seated on the upper portion thereof advance in the direction of the entrance conveyor (31).

In addition, when the inner mold (51) moves to the outside of the volume reducing part (7) along the entrance conveyor (31), the dry active waste, which is radioactive waste, is supplied to the inside of the inner mold (51). In this case, there are various methods of supplying the dry active waste to the inner mold (51), and for example, it may be supplied by using a robot arm or by manpower.

When the inner mold (51) is filled with the dry active waste, the entrance conveyor (31) is driven to return the mold tray (55) and the inner mold (51) to the compacting position (P).

In this case, the plurality of fixing grooves (63) are formed on the bottom surface of the mold tray (55), and the plurality of fixing grooves (63) are inserted into the plurality of fixing protrusions (65) protruding from the upper surface of the lower support part (43), so that the mold tray (55) may be fixed in its normal position.

In this state, as the second hydraulic cylinder (13) is driven, the connecting member (38) is lowered, and the outer mold (53) is lowered. In addition, the lowered outer mold (53) is coupled to the outside of the inner mold (51). Then, by rotating the handle (39), the outer mold (53) and the inner mold (51) are integrally coupled. In this case, the rotation of the handle (39) may be performed by an automated robot or tool.

After the outer and inner molds (51, 53) are coupled, the first hydraulic cylinder (12) is driven, so that the pressure press (37) is lowered.

In addition, the pressure press (37) compacts the stored dry active waste at a certain pressure by entering the inside of the inner mold (51).

After the dry active waste is compacted for a certain time, the connecting member (38) is lifted by driving the second hydraulic cylinder (13), so that the inner and outer molds (51, 53) are lifted. In this case, the pressure press (37) maintains the lowered position as it is. In addition, the mold tray (55) is also left at the compacting position (P).

Accordingly, since the inner mold (51) is in the lifted state and the pressure press (37) is in the stopped state, the dry active waste stored in the inner mold (51) is pressed downward by the pressure press (37) to be separated from the inner mold (51) in the compacted state.

When the separated compacted dry active waste is seated on the upper side of the mold tray (55), the first hydraulic cylinder (12) is driven, so that the pressure press (37) is lifted.

Then, the mold tray (55) is moved in the exit direction by the exit conveyor (33), and is appropriately processed at the exit side. For example, after being transported by a crane, it is put into a packaging drum and disposed of.

As described above, when the dry active waste is processed, the mold tray (55) returns to the compacting position (P), which is an original position, by the exit conveyor (33).

Then, as the second hydraulic cylinder (13) is driven again, the connecting member (38) is lowered, and the inner and outer molds (51, 53) are lowered.

When the inner and outer molds (51, 53) are lowered, the handle (39) is rotated to separate the inner mold (51) from the outer mold (53), and the outer mold (53) is lifted again.

In addition, the lowered inner mold (51) may be seated on the upper surface of the mold tray (55), and may be fixed to its normal position by a combination of the plurality of fixing grooves (63) and fixing protrusions (65).

In this state, by repeating the initial process again, the compacting process of the dry active waste may be efficiently performed.

Meanwhile, the melting part (9) for melting the dry active waste, and the exhaust gas processing part (11) connected to the melting part (9) and exhausting the discharged gas to the outside are disposed on the other side of the inside of the container (5).

This melting part performs a method of melting the dry active waste by plasma. That is, the dry active waste is melt-processed in a plasma melting furnace (17), and the generated exhaust gas is processed in the exhaust gas processing part (11) to be discharged to the outside. In this case, the generated organic and inorganic solid and liquid waste is recycled and treated, so secondary waste is not generated.

The melting part (9) includes the plasma melting furnace (17) in which the dry active waste is stored; a plasma torch (19) that is disposed in the plasma melting furnace (17) and generates ultra-high heat by electric arc to generate gaseous plasma to melt the dry active waste; and a manipulator (15) that controls a direction of the plasma torch (19).

The plasma melting furnace (17) secures an inner product at a level that may be mounted on a trailer by designing the body 59 of the melting furnace (17) in a cylindrical shape with an inner diameter of about 1 m and a height of about 15 m, but preferably has a cooling function with a double jacket structure.

In addition, c-MgO refractory bricks may be stacked inside the furnace (17), or a cold crucible may be installed therein.

The plasma melting furnace (17) melts non-combustible radiative materials (average radiation 02412 Ci/mm3) such as concrete, glass, asbestos, metal fittings, and waste filters by injecting 20 Kg per hour based on a 150 KAW torch (19).

When melt-processed at about 1,500 to 1,800° C., organic components are completely decomposed, inorganic components are stabilized, gas flows into the exhaust gas processing part (11), and some radionuclides are confined to a slack phase.

The gas flowing into the exhaust gas processing part (11) sequentially passes through a metal filter (21), a scrubber (23) for collecting sulfides, a heme filter (25), a heater (27), and an NOx remover (29) and then is discharged to the outside through an outlet vent (30).

As described above, by respectively disposing the volume reducing part (7) and the melting part (9) in the container (5) of the vehicle (3), it is possible to easily access the site and easily perform the melting operation and the volume reduction operation for the dry active waste.

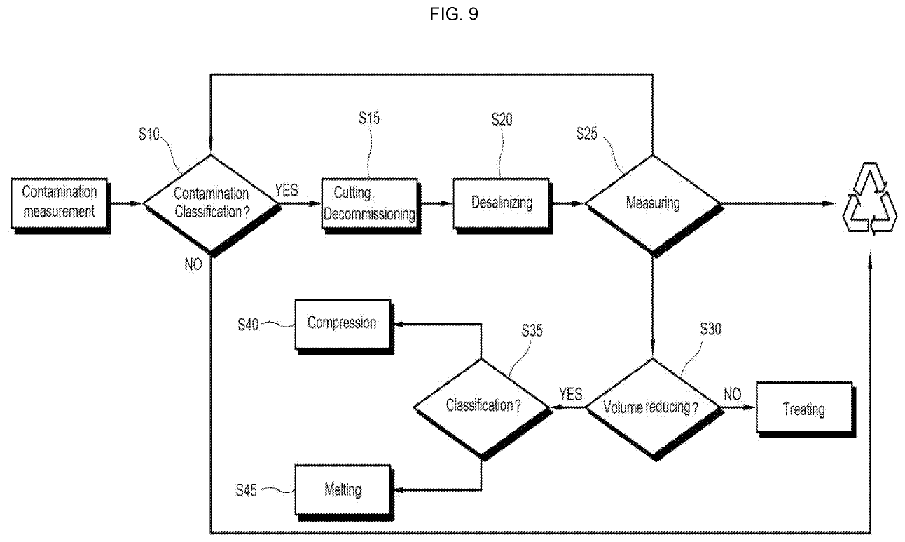

Meanwhile, the operation process of the volume reducing part (7) and the melting part (9) may be performed according to a sequence shown in FIG. 9.

First, a first step (S10) in which contamination measurement and classification of radioactive waste is performed is performed. When it is determined that it is contaminated, a second step (S15) of cutting and decommissioning the radioactive waste is performed, and when it is determined that it is not contaminated, it is recycle-processed.

After completion of the second step (S15), a third step (S20) of desalinizing the radioactive waste is performed, and a fourth step (S25) of measuring radiation is performed.

As a result of the measurement, the first step (S10) is performed again when the measurement result is greater than or equal to an intermediate level, and a fifth step (S30) of storing the radioactive waste in the inner mold (51) is performed when the measurement result is smaller than or equal to a low level.

After the fifth step (S30) is performed, a sixth step (S35) is performed, and the inner mold (51) in which the radioactive waste is stored is classified into compressible, incompressible, combustible, and non-combustible waste, and it is classified into an object to be processed by conveying it to the volume reducing part (7) and an object to be processed by conveying it to the melting part (9).

After being classified in the sixth step (S35), a seventh step (S40) in which the inner mold (51) is conveyed to the volume reducing part (7) to be compacted is performed.

In the seventh step (S40), various types of radioactive waste are processed by the volume reducing part (7), for example, piping, structures, equipment, work clothes, non-woven fabric, packaging materials, covers, instruments, filters, and the like.

In addition, an eighth step (S45) in which they are transferred to the melting part (9) and melted, is performed.

In the eighth step (S45), the radioactive waste is processed by the melting part (9), for example, it includes soil, concrete and metal powder, metal and concrete script, various sludge, and the like.

In processing such dry active waste, the processing operations by the volume reducing part (7) and the melting part (9) may be simultaneously performed, or one thereof may be first performed.

Meanwhile, in the case of processing them by combining the volume reducing part (7) and the melting part (9), the inner drum (51) may be conveyed by a conveying conveyor disposed between the volume reducing part (7) and the melting part (9) and then be processed.

That is, the conveying conveyor is disposed on the bottom of the container (5) of the vehicle (3), one side thereof is connected to the volume reducing part (7), and the other side thereof is connected to the melting part (9).

Accordingly, as necessary, the inner mold (51) may be conveyed from the volume reducing part (7) to the melting part (9), or conversely, the inner mold (51) may be conveyed from the melting part (9) to the volume reducing part (7).

### INDUSTRIAL APPLICABILITY

The present invention relates to a mobile compacting and melting complex volume reduction system and method of nuclear power plant waste, and relates to a technology that, by installing a system capable of compacting and melting dry active waste of nuclear power plant waste in a vehicle and movably configuring it, may access a processing place without restrictions and that may selectively perform compacting or melting according to types of radioactive waste, thus it is applicable to the field of radioactive waste.

1. A mobile compacting and melting complex volume reduction system (1), comprising:
a mobile vehicle (3);
a volume reducing part (7) that is disposed at one side of the inside of a container (5) mounted on the vehicle (3), and that presses and compacts dry active waste;
a melting part (9) that is disposed at one side of the inside of the container (5) to melt the dry active waste by heat of a high temperature; and
an exhaust gas processing part (11) that is connected to the melting part (9) to exhaust discharged gas to the outside.

2. The mobile compacting and melting complex volume reduction system (1) of claim 1, wherein
the volume reducing part (7) includes an upper frame (10); first to third hydraulic cylinders (12, 13, 14) that are disposed at the upper frame (10) side to ascend or descend; a pressure press (37) that compacts the dry active waste by being connected to a lower portion of the first hydraulic cylinder (12) to ascend or descend; an inner mold (51) that is disposed under the pressure press (37) and in which the dry active waste is stored therein as a cylindrical shape to be pressed by the pressure press (37); an outer mold (53) that is disposed to surround the outside of the inner mold (51) and has a cylindrical shape; a connecting member (38) that lifts and lowers the outer mold (53) by connecting the second hydraulic cylinder (13) and the outer mold (53); a mold tray (55) that is detachably mounted on lower portions of the inner and outer molds (51, 53) to seal a lower portion thereof; a lower support part (43) that is connected to a lower portion of the third hydraulic cylinder (14) to ascend or descend and in which the mold tray (55) is mounted on at upper side thereof; a rail (50) that is disposed in a rail groove (56) formed in the lower support part (43), and supports a lower portion of the mold tray (55) by ascending or descending to move up or down and forward and backward it; and entrance and exit conveyors (31, 33) that are respectively disposed at entrance and exit sides of the lower support (43) to move the mold tray (55) to take out the inner mold (51) to the outside or move it to an inner pressing position.

3. The mobile compacting and melting complex volume reduction system (1) of claim 2, wherein
the mold tray (55) has a plate shape, and the inner and outer molds (51, 53) are mounted on an upper portion thereof, a pair of coupling grooves (h) are formed in a lower portion thereof, and a pair of rails (50) are respectively coupled to the coupling groove (h).

4. The mobile compacting and melting complex volume reduction system (1) of claim 2, wherein
the inner mold (51) and the outer mold (53) are integrally coupled or separated by a handle (39).

5. The mobile compacting and melting complex volume reduction system (1) of claim 1, wherein
the melting part (9) includes a plasma melting furnace (17) in which the dry active waste is stored; a plasma torch (19) that is disposed in the plasma melting furnace (17) and generates ultra-high heat by electric arc to generate gaseous plasma to melt the dry active waste; and a manipulator (15) that controls a direction of the plasma torch (19).

6. A mobile compacting and melting complex volume reduction method, comprising:
a first step (S10) in which contamination measurement and classification of radioactive waste is performed;
a second step (S15) of cutting and decommissioning the radioactive waste when it is determined to be contaminated;
a third step (S20) of desalinizing the radioactive waste;
a fourth step (S25) of measuring radiation thereof;
a fifth step (S30) of performing again the first step (S10) when the measurement result is greater than or equal to an intermediate level and of storing the radioactive waste in the inner mold (51) is performed when the measurement result is smaller than or equal to a low level;
a sixth step (S35) of classifying the inner mold (51) in which the radioactive waste is stored into compressible, incompressible, combustible, and non-combustible ones, and classifying it into an object to be processed by conveying it to the volume reducing part (7) and an object to be processed by conveying it to the melting part (9);
a seventh step (S40), after being classified in the sixth step (S35), of conveying the inner mold (51) to the volume reducing part (7) to compact it; and
an eighth step (S45), after being classified in the sixth step (S35), of conveying the inner mold (51) to the molten part (9) and melting it.
